(19) United States
(12) Patent Application Publication
(10) Pub. No.: US 2003/0214395 A1
(43) Pub. Date: Nov. 20, 2003

(54) Removable tire characteristic receiver

(75) Inventors: Craig D. Flowerday, Holland, MI (US); Nels Smith, Holland, MI (US); David J. Spykerman, Zeeland, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/145,867

(22) Filed: May 14, 2002

(51) Int. Cl. B60C 23/00

(52) U.S. Cl. 340/445

(57) ABSTRACT

A tire characteristic receiver comprises a receiver circuit, a processing circuit, and a housing. The receiver circuit is configured to receive tire characteristic data wirelessly from a vehicle tire. The processing circuit is configured to receive the tire characteristic data and to provide the tire characteristic data to an operator interface device. The housing is coupled to the processing circuit and the receiver circuit and is removably coupleable to a vehicle interior element.

### BACKGROUND OF THE DISCLOSURE

Ground-based vehicles, such as automobiles, construction and agricultural vehicles, and motorcycles, typically include inflatable tires for contacting the ground. Inflatable tires must be maintained at the proper pressure and temperature, and have adequate tread depth. The condition of the tires can be assessed during regular service visits, but should also be assessed at more frequent intervals by the vehicle owner to ensure optimal performance.

Various techniques are known for monitoring tire characteristics. Those systems offering the greatest ease of use include a tire monitor fixedly mounted within the vehicle which receives tire pressure signals wirelessly from pressure sensors mounted in each tire. In one exemplary system, radio frequency (RF) technology is used as a medium between an RF transmitter coupled to a pressure sensor inserted into a vehicle tire and an RF receiver fixedly mounted in the vehicle. The RF transmitter transmits signals including tire identification data and tire pressure information. The receiver is pre-programmed to associate the tire identification data with a tire position on the vehicle (e.g., left front, left rear, spare tire, etc.). The receiver displays the tire pressure for each tire position.

Other systems which are useful for service personnel are hand-held devices which are brought in the vicinity of a vehicle tire. An RF request signal is transmitted to a tire sensor/transceiver. In response, the transceiver sends a short-range RF signal to the hand-held transmitter. The hand-held transmitter displays the tire pressure of the nearby tire to the operator.

One disadvantage of the fixed, in-vehicle system is that it does not provide a suitable solution for service personnel who wish to check characteristics of the tire. Therefore, an additional hand-held system is required. Also, the fixed, in-vehicle system does not allow the vehicle owner to view the tire while it is being filled with air, since the monitor is disposed inside the vehicle and the display is disposed for viewing from the vehicle interior. Therefore, the vehicle occupant must still have a portable, hand-held tire pressure gauge of some sort to use while filling the tire with air.

The hand-held device has the disadvantages of only being operable while the vehicle is stationary, and requiring the user to work outside of the vehicle.

Accordingly, what is needed is a removable tire characteristic receiver for a vehicle. Further, what is needed is a tire characteristic receiver operable from both within a vehicle interior during driving and outside a vehicle during service. Further still, what is needed is a tire characteristic receiver that utilizes one receiver for receiving tire characteristic signals wirelessly from vehicle tires when used within a vehicle interior or outside a vehicle interior. Further yet, what is needed is a tire characteristic receiver that can identify tire positions on a vehicle from both inside and outside the vehicle.

The teachings hereinbelow extend to those embodiments which fall within the scope of the appended claims, regardless of whether they accomplish one or more of the above-mentioned needs.

### SUMMARY OF EXEMPLARY EMBODIMENTS

According to one exemplary embodiment, a tire characteristic receiver comprises a receiver circuit, a processing circuit, and a housing. The receiver circuit is configured to receive tire characteristic data wirelessly from a vehicle tire. The processing circuit is configured to receive the tire characteristic data and to provide the tire characteristic data to an operator interface device. The housing is coupled to the processing circuit and the receiver circuit and is removably coupleable to a vehicle interior element.

According to another exemplary embodiment, a tire pressure monitor comprises a housing, an operator interface, a receiver, a processing circuit, and a mechanical coupling. The housing is configured to be held in an operator's hand. The operator interface device is coupled to the housing. The receiver is coupled to the housing and is configured to receive tire pressure data and tire identification data wirelessly from a plurality of vehicle tires. The processing circuit is coupled to the housing and is configured to receive the tire pressure data and tire identification data and to provide the tire pressure data to an operator via the operator interface device. The mechanical coupling is coupled to the housing and is configured to mount the housing to a vehicle interior element in a removable manner.

According to yet another exemplary embodiment, a tire characteristic monitor comprises a means for receiving tire characteristic data wirelessly from a vehicle tire and a means for providing the tire characteristic data to an operator interface device. The tire characteristic monitor further includes a means for removably coupling the tire characteristic monitor to a vehicle interior element.

### BRIEF DESCRIPTION OF THE DRAWINGS

The invention will become more fully understood from the following detailed description, taken in conjunction with the accompanying drawings, wherein like reference numerals refer to like parts, and in which:

FIGS. 1 and 2 are front view and rear view schematic diagrams of a tire characteristic receiver, according to an exemplary embodiment;

FIG. 3 is a block diagram of the tire characteristic receiver of FIGS. 1 and 2, according to an exemplary embodiment;

FIG. 4 is a schematic diagram of the tire characteristic receiver of FIG. 1 removably coupled to a vehicle interior element, according to an exemplary embodiment;

FIG. 5 is a schematic diagram of the tire characteristic receiver of FIG. 1 illustrating use outside of the vehicle interior;

FIG. 6 is a cross-sectional diagram of the tire characteristic receiver of FIG. 1 before coupling to a vehicle interior element, according to an exemplary embodiment;

FIG. 7 is a cross-sectional diagram of the tire characteristic receiver of FIG. 1 after coupling to a vehicle interior element, according to an exemplary embodiment;

FIG. 8 is a perspective view of a tire characteristic receiver and a vehicle interior element, according to another exemplary embodiment;

FIG. 9 is a cross-sectional view of the tire characteristic receiver of FIG. 8 illustrating the tire characteristic receiver being coupled to the vehicle interior element;

FIG. 10 is perspective view of a tire characteristic receiver and a vehicle interior element, according to another exemplary embodiment;

FIG. 11 is a perspective view of a tire characteristic receiver, according to another exemplary embodiment;

FIG. 12 is a perspective view of the tire characteristic receiver of FIG. 11 coupled to a vehicle interior element, according to an exemplary embodiment;

FIG. 13 is a perspective view of a cellular phone integrated with a tire characteristic receiver, according to an exemplary embodiment;

FIG. 14 is a vehicle finder integrated with a tire characteristic receiver, according to an exemplary embodiment;

FIG. 15 is a tire characteristic receiver having one or more utility instruments and a storage space, according to an exemplary embodiment; and

FIG. 16 is a block diagram of a removable charging unit for a vehicle, according to an exemplary embodiment.

### DETAILED DESCRIPTION OF EXEMPLARY EMBODIMENTS

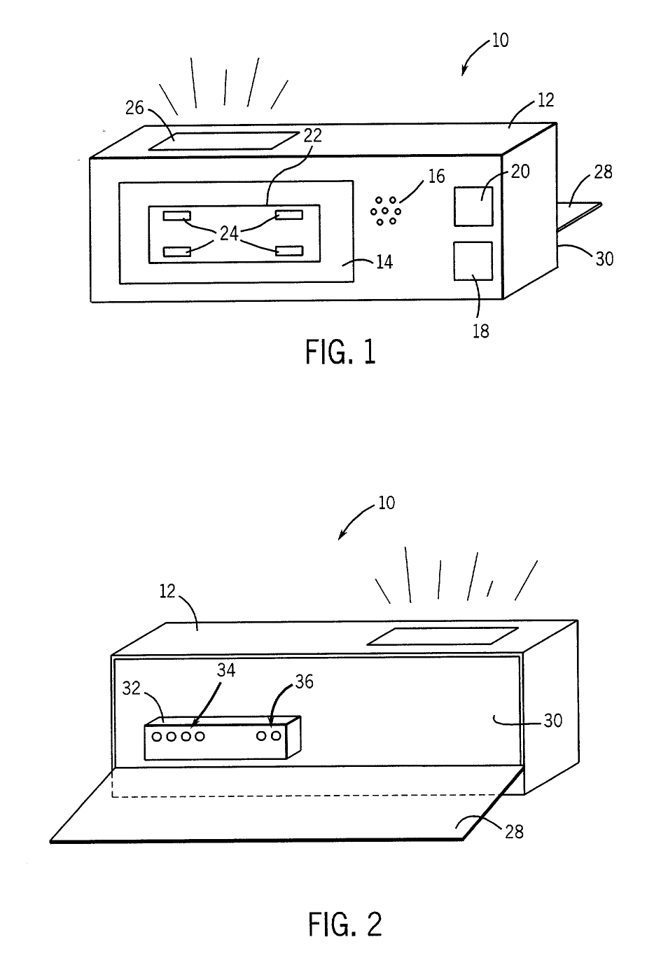

Referring first to FIG. 1, a tire characteristic receiver 10 is illustrated. Tire characteristic receiver 10 is advantageously removably coupleable to a vehicle and, more particularly, configured for mounting to a vehicle interior element in a removable manner, as will be described hereinbelow. In this exemplary embodiment, tire characteristic receiver 10 includes a housing 12 or base member having a size suitable for being held in an operator's hand. For example, the housing can encompass a volume of less than 1,000 cubic inches or less than 800 cubic inches for a smaller, more compact version.

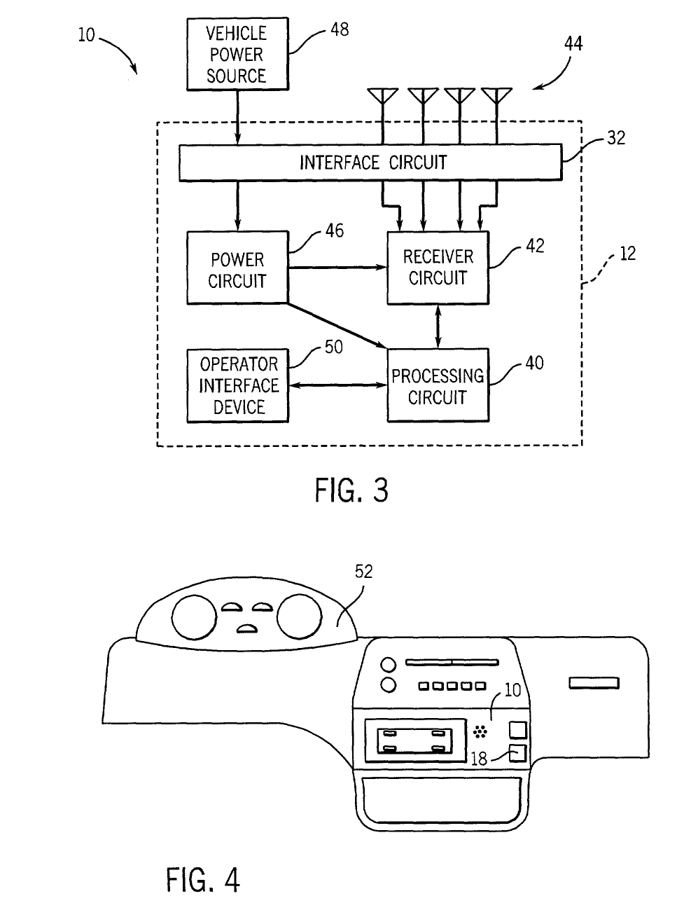

Housing 12 encompasses a receiver circuit configured to receive tire characteristic data from one or more vehicle tires, a processing circuit configured to process the tire characteristic data and to provide an output to the operator, and a power circuit, all of which will be described hereinbelow with reference to FIG. 3. Generally, tire characteristic receiver 10 receives tire characteristic signals representing tire characteristic data (e.g., tire pressure, tire temperature, tread depth, etc.) along a wireless transmission (e.g., infrared, radio frequency, etc.) from one or more tires coupled to a vehicle. Receiver 10 processes the data, including identifying the location of the tire associated with each received tire characteristic data, and provides this data to an operator of a vehicle via an operator interface device.

As illustrated in FIG. 1, receiver 10 includes one or more operator interface devices, such as, a display 14, a speaker 16, a release switch 18, and a light on/off switch 20. Receiver 10 is configured to provide tire characteristic data to the operator via either or both of display 14 and speaker 16. In this embodiment, display 14 is a liquid crystal display (LCD), vacuum fluorescent display, or other type of display. A vehicle icon 22 is illustrated including four tire icons 24. A low pressure or high pressure condition, or other tire condition, or the actual tire pressure of one or more of the vehicle tires can be illustrated on display 14 by using a unique color, shading, or other display format for the tire icon corresponding to the vehicle condition. The tire condition or characteristic data can be provided via speaker 16 or on display 14. An additional input switch may be used by the operator to select one of the vehicle tires for display and to further select a tire characteristic for display. For example, display 14 may be configured by the operator to show the tire pressure associated with the left front tire. Any type of input device may be used, such as, buttons, switches, dials, touch-screens, and voice recognition, to receive comments from an operator for controlling the output at display 14 and/or speaker 16.

Speaker 16 may be used to transmit an audible message corresponding to tire characteristic data to the operator. Both display 14 and speaker 16 are under control of the processing circuit, as will be described hereinbelow.

Receiver 10 further includes a light source 26 which is turned on or off by a light on/off switch 20. Switch 20 may be a toggle, push button switch, or other type of switch. Light source 26 is configured to provide illumination to the surrounding area, which is particularly advantageous when used in the vicinity of a vehicle tire which may be flat or otherwise require maintenance when the ambient light is low.

Receiver 10 may further include a stand 28 hingedly coupled to a back surface 30 of receiver 10. Stand 28 may be opened such that receiver 10 can rest upon stand 28 when used away from a vehicle interior, and stand 28 may be folded flush with back surface 30 when receiver 10 is used in a hand-held mode or when receiver 10 is coupled to a vehicle interior element.

Referring now to FIG. 2, back surface 30 of receiver 10 is shown. An interface circuit 32 is coupled to housing 12 and is configured to be coupled to one or more detectors or antennas (not shown) and may also be configured to be coupled to a vehicle power source. Detector terminals 34 on interface circuit 32 provide electrical conductivity between the detectors (of which there are four in this exemplary embodiment, but there may alternatively be only one detector or other numbers of detectors) and the receiver circuit within housing 12. Power terminals 36 are configured to provide electrical conductivity between a vehicle power source and a power circuit within housing 12. Interface circuit 32 may take various forms, including plastic, metal, recessed connectors, 9-pin connectors, or other interface circuits.

The embodiment of FIGS. 1 and 2 discloses a housing 12 which completely encloses a receiver circuit and a processor circuit. Advantageously, housing 12 may provide radio frequency shielding to prevent interference of surrounding radio waves with the operations of the receiver circuit within receiver 10. Alternatively, one or more of the receiver circuit or the processing circuit may be mounted with a portion extending outside of housing 12.

Detector terminals 34 in interface circuit 32 comprise an exemplary detector coupling configured to couple housing 12 to one or more detectors, wherein wireless data signals from the vehicle tires are provided through the detectors, through the detector coupling to the receiver circuit within housing 12. Power terminals 36 in interface circuit 32 further comprise an exemplary power coupling which is configured to receive power from a vehicle and to provide the vehicle power to the processing circuit, the receiver circuit, or both within housing 12. These couplings may take various alternative configurations.

Referring now to FIG. 3, a block diagram of receiver 10 is illustrated according to an exemplary embodiment. Receiver 10 includes a processing circuit 40, which may include one or more analog or digital components, such as microprocessors, microcontrollers, application specific integrated circuits (ASICs), or other processing circuitry. Processing circuit 40 is coupled to a receiver circuit 42, both of which are disposed within housing 12. Receiver circuit 42 includes the necessary amplifying, mixing, demodulating, and/or other circuitry necessary for receiving and demodulating wireless tire characteristic signals from transmitters located on each vehicle tire via detectors 44. Detectors 44 are antennas in this exemplary embodiment, but may alternatively be infrared receivers, or other signal detectors. Interface circuit 32 is disposed between detectors 44 and receiver circuit 42. A power circuit 46 provides power to processing circuit 40 and receiver circuit 42. Power circuit 46 is illustrated as drawing power through interface circuit 32 from a vehicle power source 48, such as a vehicle battery. Alternatively, power circuit 46 may include a battery which does not draw power from vehicle power source 48. Alternatively, power circuit 46 may comprise a rechargeable battery, such as a nickel cadmium, lithium ion, or other type of rechargeable battery which is rechargeable from vehicle power source 48 when receiver 10 is coupled thereto. Processing circuit 40 may further utilize power management techniques in the case of a battery-operated system to promote a longer battery life.

Receiver 10 further includes an operator interface device 50 which may include display 14 and/or speaker 16 (see FIG. 1). Operator interface device 50 may further include light on/off switch 20 and any other operator input or output devices.

Receiver 10 can be configured to monitor tire characteristics on one or more vehicle tires as disclosed in commonly assigned U.S. application Ser. No. 09/896,528 to Honeck et al., which is herein incorporated by reference in its entirety. Receiver 10 can further operate as disclosed in commonly assigned U.S. application Ser. No. 09/931,456, to Vredevoogd et al., which is herein incorporated by reference in its entirety.

Receiver 10 is configured to receive tire characteristic signals (e.g., tire pressure data, tire temperature data, tire tread depth data, etc.) from transmitter/sensor units on each of a plurality of vehicle tires via a wireless link (e.g., radio frequency, infrared, etc.) at detectors 44. The tire characteristic signals are provided to receiver circuit 42 which demodulates the data on the signals and provides the data to processing circuit 40 for further processing. Processing circuit 40 is configured to receive the tire characteristic data and to provide the tire characteristic data to operator interface device 50. Processing circuit 40 may be programmed manually or automatically to identify the location of the tire associated with the data received and can further provide this data to operator interface device 50. The received tire characteristic data from each transmitter/sensor unit includes tire identification data and one or more items of tire characteristics. Processing circuit 40 may be configured to identify the positions of a plurality of tires on the vehicle based on the tire identification data, or based on pre-programmed data.

Receiver 10 may further be configured as a trainable transceiver in which a wireless message is received, for example, for a garage door opener, characteristics of the wireless message are stored, such as, bit encoding scheme, frequency, etc., and a wireless signal is transmitted from receiver 10 in response to operator actuation of a switch, when the transmitted signal is based on the recorded characteristics. In this embodiment, receiver circuit 42 acts as a transceiver circuit capable of both receiving and transmitting a wireless message. Exemplary trainable transceiver systems are described with specificity in U.S. Pat. No. 5,854,593 to Dykema et al., which is hereby incorporated by reference in its entirety.

Further still, receiver 10 may be configured to receive a remote keyless entry signal indicative of a request to lock or unlock a vehicle door, to turn a security feature on or off, or to operate another system within the vehicle. In this example, receiver 10 includes an interface to a vehicle system via a vehicle bus or via a direct wired or wireless link to operate the vehicle system in accordance with the command received from the remote keyless entry transmitter (e.g., a keyfob).

Advantageously, receiver 10 may be configured for one or more of tire characteristic monitoring, trainable transceiver, or remote keyless entry functions described hereinabove using the same set of receive circuitry and processing circuitry. Furthermore, all three functions can be provided in a housing 12 which is removably coupleable to a vehicle interior element, as will now be described.

Referring now to FIG. 4, receiver 10 is illustrated in a position wherein receiver 10 is coupled to a vehicle interior element 52. The vehicle interior element is an instrument panel in this exemplary embodiment, but may alternatively be an overhead compartment, a floor console, a trunk, a vehicle seat, a headliner, a visor, a glove box, a door, a lift gate, etc.

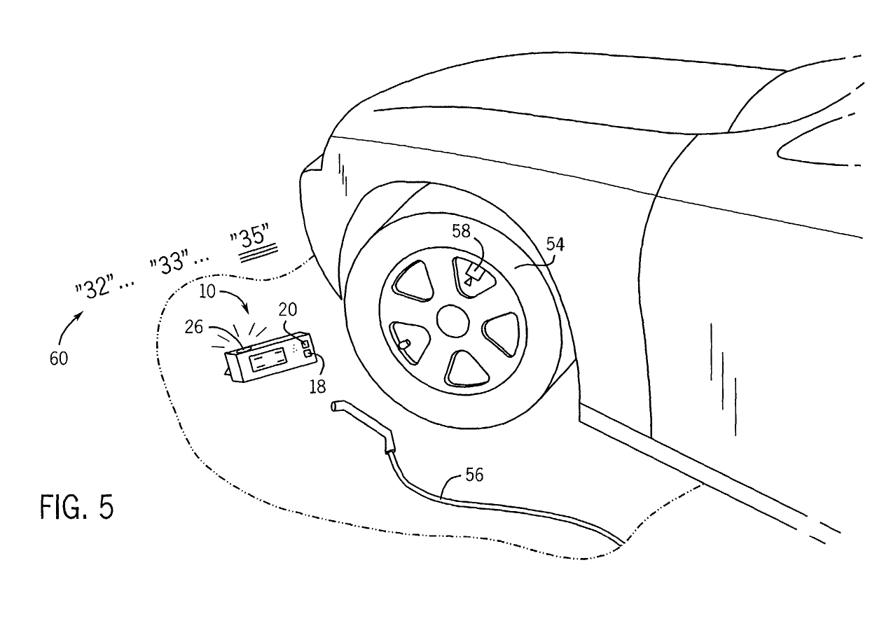

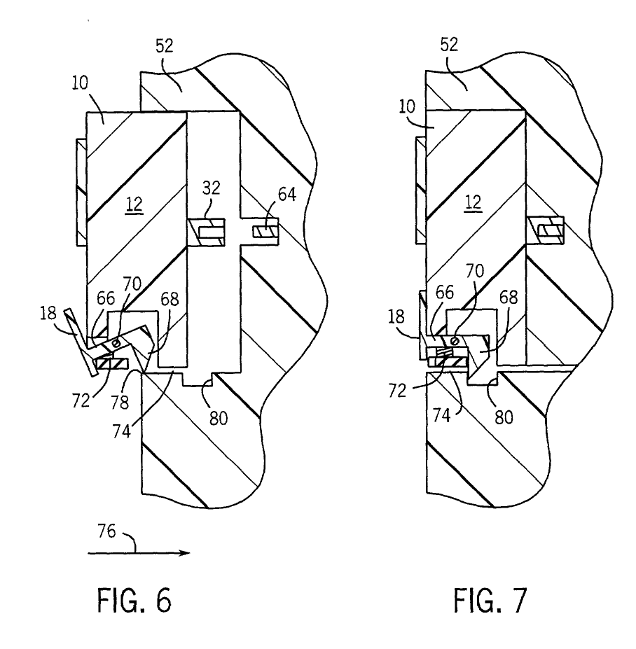

As illustrated in FIG. 5, receiver 10 is removable from vehicle interior element 52 for use outside of a vehicle interior. An exemplary removable coupling arrangement will be described with reference to FIGS. 6 and 7 hereinbelow, although any suitable coupling arrangement can be used. Referring again to FIG. 4, in response to user actuation of release switch 18, receiver 10 becomes removable from vehicle interior element 52 for use outside of the vehicle. In this exemplary embodiment, receiver 10 is removable from vehicle interior element 52 only in response to an operator-actuated switch, and otherwise remains in a coupled configuration with vehicle interior element 52.

As illustrated in FIG. 5, receiver 10 may be placed near a vehicle tire 54 while an operator or service technician is checking the characteristics of the tire and servicing the tire, for example, by adding pressure with a tire pressure hose 56. Light source 26 can be enabled by light switch 20 to provide light to the surrounding area as the vehicle tire is checked and/or serviced.

According to one advantageous feature, as pressure is added to tire 54, the transmitter/sensor circuit 58 coupled to tire 54 continuously sends messages including tire identification data and tire characteristic data to receiver 10. Receiver 10 is configured to provide an audible indication 60 of the tire pressure as pressure is added. The audible indication or message 60 can be enabled by the user pressing a switch on receiver 10, and likewise disabled. Audible messages can be transmitted from receiver 10 at increments of one pressure per square inch (PSI), only at the tire pressure fill limit (e.g., 35 PSI), or in other configurations. Advantageously, a single tire characteristic receiver can be used both in the vehicle to monitor the tire characteristics of vehicle tires while driving, and then used outside of the vehicle when servicing a tire or checking the status of the tire.

According to one alternative feature, receiver 10 is configured to identify a vehicle tire nearest to receiver 10 based on the tire characteristic data and without operator input. Receiver 10 calculates the strength of signals received from each transmitter/sensor in each vehicle tire and indicates to the operator via display 14 which tire is nearest by assuming the tire with the strongest signal strength (RSSI or received signal strength indicator) is nearest. Other alternative methods of identifying the positions of the vehicle tires on the vehicle are contemplated.

Referring now to FIGS. 6 and 7, cross-sectional views of vehicle interior element 52 and receiver 10 are illustrated. FIGS. 6 and 7 illustrate an exemplary removable coupling arrangement or mechanical coupling for coupling housing 12 of receiver 10 to vehicle interior element 52. In this exemplary embodiment, vehicle interior element 52 includes a mating interface circuit 62 configured to interface in a mating arrangement with interface circuit 32. Mating interface circuit 62 includes a plurality of electrical contacts 64 configured to provide vehicle power and/or detector signals to interface circuit 32.

The mechanical coupling for providing releasable connection or removable coupling in this exemplary embodiment includes release switch 18 coupled to a lever 66 which is coupled to a protuberance 68. A pivot 70 is coupled to housing 12. A spring 72 biases lever 66 in a clockwise direction as illustrated to bias protuberance 68 outward from housing 12 through an aperture 74 in housing 12. As housing 12 is slid into vehicle interior element 52 in the direction of arrow 76, protuberance 68 is biased inward to housing 12 by leading edge 78 of vehicle interior element 52. As housing 12 continues to slide into vehicle interior element 52, protuberance 68 meets an aperture 80 in vehicle interior element 52. At this juncture, spring 72 biases lever 66 clockwise and moves protuberance 68 into a locking arrangement within aperture 80. To remove receiver 10, release switch 18 is actuated to move lever 66 in a counterclockwise direction around pivot 70 to remove protuberance 68 from aperture 80, thereby allowing housing 12 to be removed. One of ordinary skill in the art will recognize that many alternative mechanical coupling, electromechanical coupling or magnetic coupling arrangements are contemplated.

According to one exemplary embodiment, when receiver 10 is removed from the vehicle, the information on display 14 continues to be displayed so that the person adding air to the vehicle tires knows how much air should be added. Receiver 10 is then used at the tire to display pressure and confirm that the appropriate amount of air is in the tire.

According to one advantageous embodiment, vehicle icon 22 on display 14 is oriented in a way that reduces confusion, specifically, by providing the front left tire of the display in coordination with the front left tire on the vehicle when display 14 is mounted on the vehicle. Furthermore, an indication can be provided on display 14 to indicate to the user a reference point on the vehicle, such as the vehicle front, to simplify proper orientation of receiver 10 during use outside of the vehicle interior.

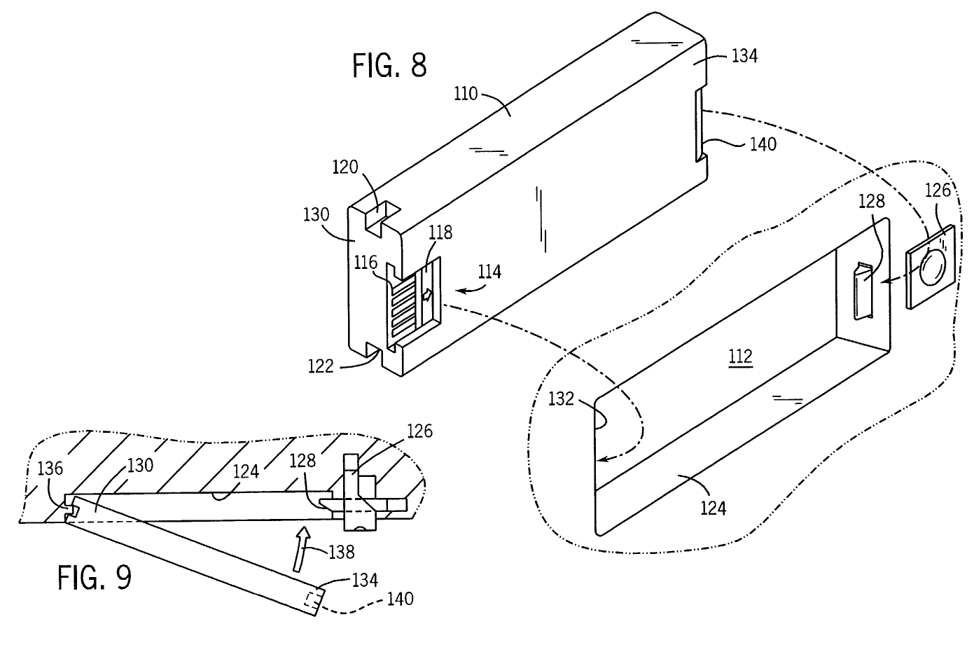

Referring now to FIG. 8, a perspective view of a tire characteristic receiver 110 and a vehicle interior element 112 is illustrated. Receiver 10 includes an interface circuit 114 having a plurality of connectors 116 and a retractable, spring-loaded door 118. Receiver 110 further includes one or more recesses 120, 122 within the housing of receiver 110. A back side of receiver 110 is illustrated in FIG. 8. Door 118 is biased in a closed position, wherein connectors 116 are covered and protected. Door 118 is configured to recess within receiver 110 in response to a force exerted thereon. The housing of receiver 110 has a size and weight such that receiver 110 can be held in a person's hand. Vehicle element 112 includes a recess 124 configured to receive housing receiver 110. Vehicle interior element 112 further includes a release button 126 which acts on a protrusion 128 which extends into recess 124.

As receiver 110 is placed into vehicle interior element 112, recesses 120, 122 are aligned with corresponding protrusions 136 (FIG. 9) from vehicle interior element 112 into recess 124. A first end 130 of receiver 110 is inserted into a first end 132 of recess 124. A second end 134 of receiver 110 is moved toward protrusion 128. Protrusion 128 is biased by a spring or other biasing device toward recess 124.

Referring to FIG. 9, first end 130 of receiver 110 is shown inserted into recess 124, wherein recesses 120, 122 fit in substantially mating alignment with protrusions 136. Second end 134 of receiver 110 is moved in the direction of arrow 138 toward protrusion 128. Second end 134 biases protrusion 128 away from recess 124 to allow receiver 110 to fit into recess 124. Protrusion 128 locks receiver 110 in place at recess 140. Button 126 is pressed to release second end 134 of receiver 110 by imparting a force on protrusion 128 to move it out of recess 140, thereby allowing receiver 110 to be removed.

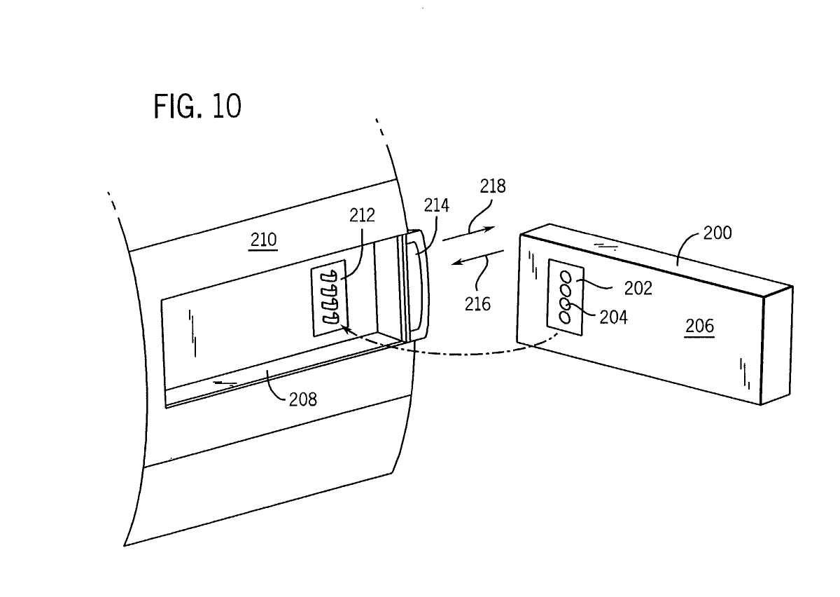

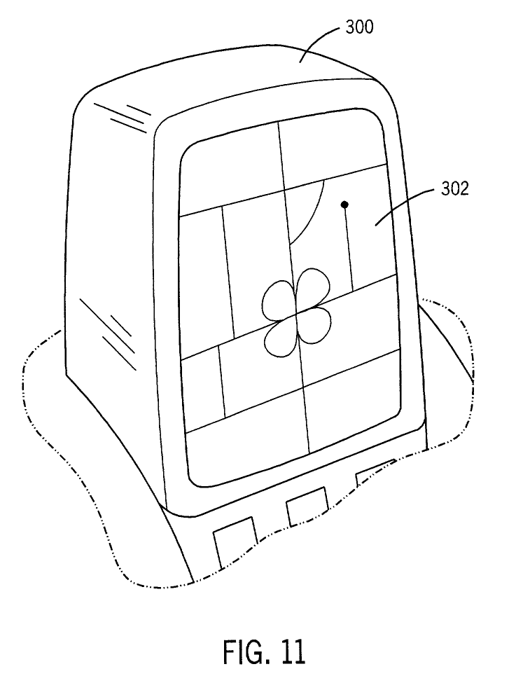

Referring now to FIG. 10, a tire characteristic receiver 200 is illustrated according to another exemplary embodiment. In this embodiment, receiver 200 includes an interface circuit 202 having connectors 204. A back side 206 of receiver 200 is placed into a mating recess 208 of vehicle element interior element 210, shown as an instrument panel. A plurality of mating contacts or interconnects 212 are configured to make contact with contacts 204. A door 214 is slidable from a closed position (in the direction of arrow 216) to an open position (in the direction of arrow 218). Alternatively, door 214 may be hinged and may include detents, an interference fit, or other structure for holding door 214 in an open and/or closed position to thereby retain and/or release receiver 200 from recess 208.

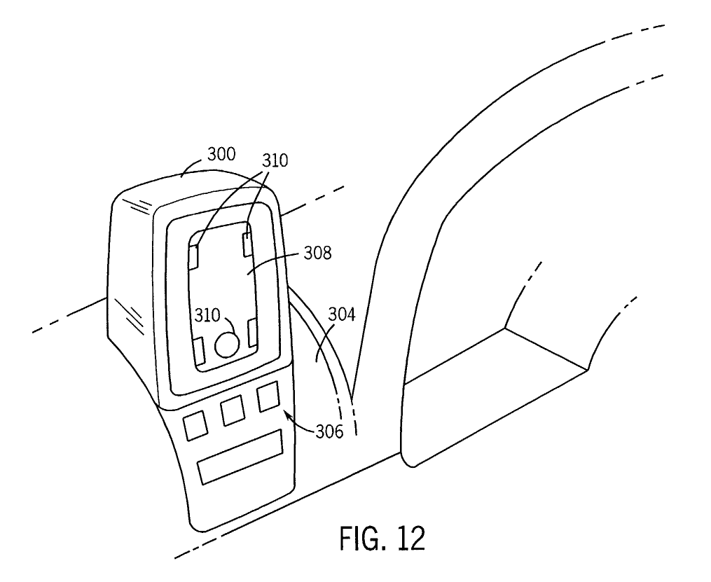

Advantageously, other features and/or functions not related to tire characteristic monitoring can be implemented with the tire characteristic receivers described in the various exemplary embodiments herein. During normal vehicle driving, when the tires are in good condition, the display on the tire characteristic receiver may be used for other vehicle functionalities. For example, as illustrated in FIG. 11 and FIG. 12, a tire characteristic receiver 300 includes a navigation function wherein a map 302 is provided on the display of receiver 300 when receiver 300 is not used for the display of tire characteristic data. As shown in FIG. 12, receiver 300 is configured to be mounted to and recessed within a vehicle interior element 304, shown here as an instrument panel. According to one embodiment, a plurality of user input devices 306 are coupled to vehicle interior element 304 and are configured to communicate with receiver 300 via an interface circuit. An icon 308 of a vehicle is illustrated having tire icons 310, which can indicate tire characteristic information. Input device 306 can be used to cycle through various functions to be displayed on the display of receiver 300. Receiver 300 may include a GPS receiver and antenna, or may receive data from a GPS receiver and antenna mounted on another location of the vehicle and connected to receiver 300 via a communication link, such as, a vehicle bus. According to one example, a map can be downloaded to receiver 300, and the map can be removed from vehicle interior element 304 and operational on battery power as a user takes receiver 300 and map 302 away from the vehicle for use outside of the vehicle.

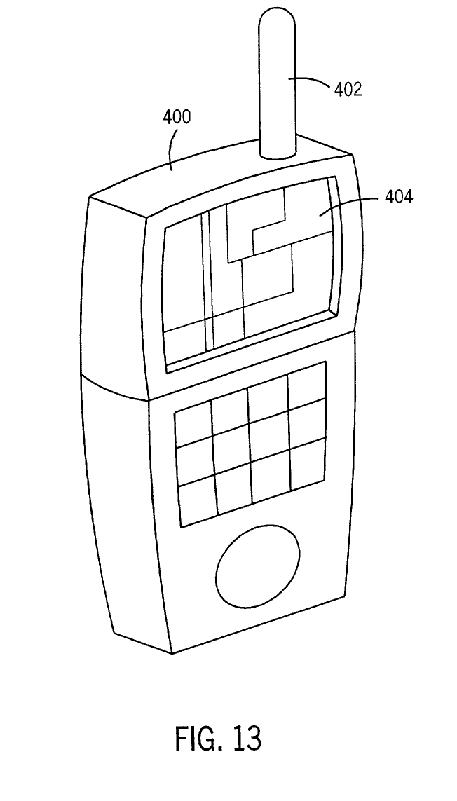

Referring to FIG. 13, another exemplary embodiment of tire characteristic receiver 400 includes an integrated wireless telephone having a retracting or folding antenna 402 such that receiver 400 can fit in a recess within the vehicle interior element. The tire characteristic receiver 400 may include a display 404 for the display of data information, including maps, and other downloaded data from a wireless communication via antenna 402.

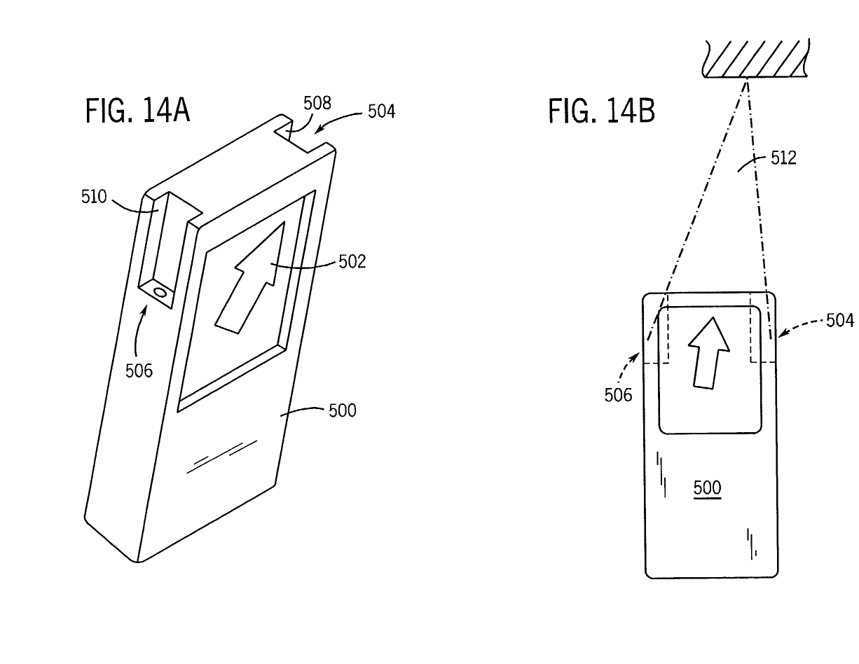

Referring now to FIG. 14, the tire characteristic receiver may be integrated in a single package with a remote object finder, such as a vehicle finder. In this embodiment, a tire characteristic receiver 500 further includes a display having an arrow icon 502, a wireless or infrared transmitter 504, and a wireless or infrared receiver 506. Transmitter 504 and receiver 506 are aimed in the same direction relative to receiver 500 and are mounted in recesses 508, 510 within the housing of receiver 500. Recesses 508 and 510 include sufficient radio frequency and/or infrared shielding. As illustrated, a signal 512 is transmitted from transmitter 504 and deflects off an object and returns to receiver 506. A control circuit within receiver 500 detects the location of the object relative to receiver 500 and provides an arrow icon indicating the direction to the object. Receiver 500 may be useful in identifying the location of a vehicle, provided the vehicle includes a tag or other device configured to deflect signal 512.

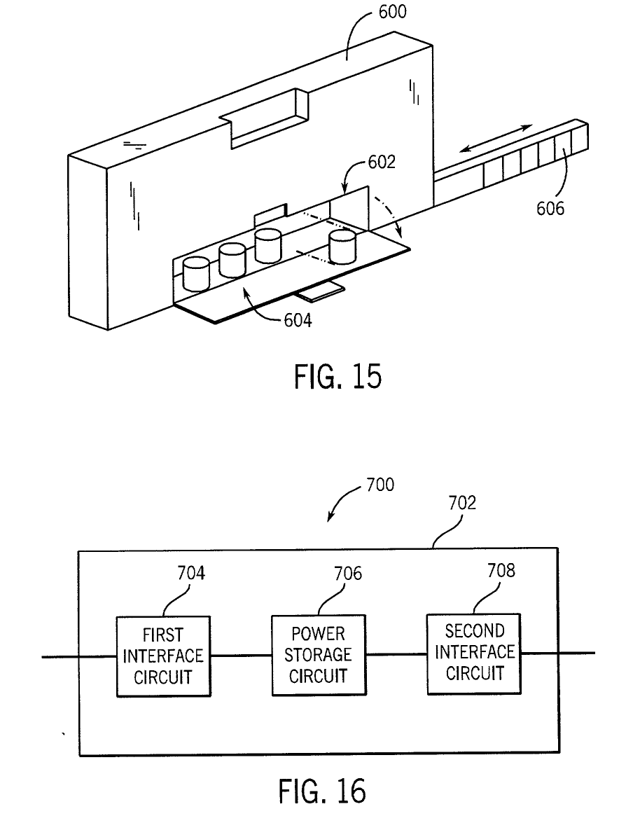

Referring now to FIG. 15, a tire characteristic receiver 600 includes a storage area 602 configured to house a plurality of tire valve stem covers 604. Receiver 600 further includes a retractable tread depth gauge 606. Other instruments may be configured for use with receiver 600.

A further feature which may be combined with the tire characteristic receiver is that of a digital voice recorder located in the visor of the vehicle. An exemplary system is illustrated in U.S. Pat. No. 5,810,420, which is herein incorporated by reference.

According to another exemplary embodiment, a removable charging unit 700 is provided for a vehicle. Unit 16 includes a housing 702 having a first interface circuit 704, a power storage circuit 706, and a second interface circuit 708 coupled thereto or disposed therein. The housing is removably coupleable to a vehicle interior element, for example using one of the methods described hereinabove. A first interface circuit 704 is coupled to the housing and configured to receive a power signal from the vehicle power (e.g., vehicle battery power). The first interface circuit is further configured to provide the power to power storage circuit 706. Power storage circuit 706 can be a battery, such as a rechargeable battery. A second interface circuit 708 is configured for coupling between power storage circuit 706 and an accessory exterior to or coupled within housing 700. For example, the accessory can be an electronic vehicle safety accessory, such as, a cellular phone, an alarm, a portable navigation system, etc. The electronic vehicle safety accessory may further be a transceiver configured to communicate voice, data, and/or other information with a remote diagnostic site, wherein the remote diagnostic site can provide assistance to the vehicle via a human operator or via an automatic dispatch service. The transceiver can communicate via cellular or other wireless telephone technologies, or may also communicate via a personal area network (PAN) or other wireless system. Advantageously, the removable charging unit for a vehicle provides battery power for one or more electronic vehicle safety accessories when vehicle power may be dissipated.

While the exemplary embodiments illustrated in the FIGS. and described above are presently preferred, it should be understood that these embodiments are offered by way of example only. For example, the coupling arrangement can take many forms, including switch-actuated arrangements, passive arrangements, electromechanical arrangements, magnetic arrangements, couplings under control of processing circuit 40, etc. Furthermore, the exemplary functionality of the receiver is not meant to preclude other or different functionalities. Accordingly, the present invention is not limited to a particular embodiment, but extends to various modifications that nevertheless fall within the scope of the appended claims.

What is claimed is:

1. A tire characteristic receiver, comprising:
a receiver circuit configured to receive tire characteristic data wirelessly from a vehicle tire;
a processing circuit configured to receive the tire characteristic data and to provide the tire characteristic data to an operator interface device; and
a housing coupled to the processing circuit and the receiver circuit, wherein the housing is removably coupleable to a vehicle interior element.

2. The tire characteristic receiver of claim 1, wherein the housing includes an interface circuit configured to be coupled to a detector mounted to the vehicle.

3. The tire characteristic receiver of claim 2, wherein the interface circuit is configured to receive vehicle power from the vehicle, the tire characteristic receiver further comprising a power circuit configured to provide power to the receiver circuit from the vehicle power.

4. The tire characteristic receiver of claim 3, further comprising a rechargeable battery configured to provide power to the receiver circuit, wherein the power circuit is configured to recharge the battery from the vehicle power.

5. The tire characteristic receiver of claim 1, wherein the operator interface device includes a speaker configured to provide an audible message indicating the tire pressure.

6. The tire characteristic receiver of claim 1, wherein the housing is removable from the vehicle only in response to an operator-actuated switch.

7. The tire characteristic receiver of claim 1, wherein the processing circuit is configured to identify a vehicle tire nearest to the housing based on the tire characteristic data and without operator input.

8. The tire characteristic receiver of claim 1, wherein the tire characteristic data represents tire pressure.

9. The tire characteristic receiver of claim 1, wherein the receiver circuit is configured to receive the tire characteristic data in the radio frequency range.

10. The tire characteristic receiver of claim 1, wherein the housing completely encloses the receiver circuit and processor circuit.

11. The tire characteristic receiver of claim 1, wherein the housing is configured for coupling to an instrument panel of the vehicle.

12. The tire characteristic receiver of claim 1, wherein the receiver circuit and processing circuit are configured to receive a wireless message, record characteristics of the wireless message, and transmit a wireless signal based on the recorded characteristics.

13. The tire characteristic receiver of claim 1, wherein the housing encompasses a volume of less than 1000 cubic inches.

14. The tire characteristic receiver of claim 1, wherein the receiver circuit is configured to receive a remote keyless entry signal and the processing circuit is configured to operate a vehicle system based on data from the remote keyless entry signal.

15. The tire characteristic receiver of claim 14, wherein the vehicle system is a door lock.

16. A tire pressure monitor, comprising:
a housing configured to be held in an operator's hand;
an operator interface device coupled to the housing;
a receiver coupled to the housing configured to receiver tire pressure data and tire identification data wirelessly from a plurality of vehicle tires;
a processing circuit coupled to the housing configured to receive the tire pressure data and tire identification data and to provide the tire pressure data to an operator via the operator interface device; and
a mechanical coupling coupled to the housing, configured to mount the housing to a vehicle interior element in a removable manner.

17. The tire characteristic receiver of claim 16, further comprising a detector coupling configured to couple the housing to a detector, wherein the tire pressure data is provided through the detector coupling to the receiver.

18. The tire characteristic receiver of claim 16, further comprising a power coupling configured to receive power from the vehicle and to provide the vehicle power to the processing circuit.

19. The tire characteristic receiver of claim 16, wherein the mechanical coupling is configured to release the housing from the vehicle interior element only in response to an operator-actuated switch.

20. The tire characteristic receiver of claim 16, wherein the processing circuit is configured to identify the positions of a plurality of tires on the vehicle based on the tire identification data.

21. A tire characteristic monitor, comprising:
means for receiving tire characteristic data wirelessly from a vehicle tire;
means for providing the tire characteristic data to an operator interface device.
means for removably coupling the tire characteristic monitor to a vehicle interior element.

22. The tire characteristic monitor of claim 21, further comprising means for removably coupling the tire characteristic monitor to a detector mounted to the vehicle.

23. The tire characteristic monitor of claim 22, further comprising means for receiving vehicle power from the vehicle and providing the vehicle power to the receiver circuit.

24. The tire characteristic monitor of claim 21, further comprising the operator interface device.

25. The tire characteristic monitor of claim 21, further comprising means for training the processing circuit to re-transmit a wireless signal received at the receiver circuit.

26. The tire characteristic monitor of claim 21, further comprising operator-actuated switch means for releasing the tire characteristic monitor from the vehicle interior element.

27. The tire characteristic monitor of claim 21, wherein the tire characteristic data includes tire identification data, further comprising means for identifying the position of each of a plurality of tires on the vehicle based on the tire identification data.

28. A removable charging unit for a vehicle, comprising:
a housing removably couplable to a vehicle interior element;
a first interface circuit coupled to the housing and configured to receive a power signal from a vehicle;
a power storage circuit coupled to the first interface circuit and configured to store power from the vehicle; and
a second interface circuit coupled to the housing and the power storage unit and configured to provide power from the power storage unit to an accessory.

29. The removable charging unit of claim 28, wherein the power storage circuit includes a rechargeable battery.

30. The removable charging unit of claim 28, wherein the second interface circuit is configured to be coupled to an electronic vehicle safety accessory.

31. The removable charging unit of claim 28, wherein the second interface circuit is configured to provide power to a transceiver configured to communicate with a remote diagnostic site.
